(19) United States
(12) Patent Application Publication
(10) Pub. No.: US 2005/0210703 A1
(43) Pub. Date: Sep. 29, 2005

(54) Drying machine

(75) Inventor: Young Suk Chung, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/086,558

(22) Filed: Mar. 23, 2005

(30) Foreign Application Priority Data
Mar. 26, 2004 (KR) 2004-20838

(51) Int. Cl. F26B 13/10

(52) U.S. Cl. 34/528; 34/550

(57) ABSTRACT

A laundry drying machine, which maintains the stable installation of a humidity sensor for a long period of time, includes a housing defining an external appearance, a drying tub rotatably installed in the housing, a front panel rotatably supporting a front end of the drying tub, and a humidity sensor, installed on the front panel, for detecting dryness of laundry contained in the drying tub. The humidity sensor of the laundry drying machine is installed on the front panel having a relatively high strength so as to support the total weight of a drying tub and laundry contained in the drying tub, thereby maintaining the stable installation of the humidity sensor for a long period of time and reducing the generation of errors of the humidity sensor.

### CROSS-REFERENCE TO RELATED APPLICATION

This application claims the benefit of Korean Patent Application No. 2004-20838, filed Mar. 26, 2004 in the Korean Intellectual Property Office, the disclosure of which is incorporated herein by reference.

### BACKGROUND OF THE INVENTION

1. Field of the Invention

The present invention relates to a laundry drying machine, and more particularly to a laundry drying machine having a humidity sensor for sensing dryness of laundry.

2. Description of the Related Art

A conventional laundry drying machine serves to dry wet laundry contained in a drying tub by forcibly blowing hot air, obtained by heating air using a heater and a fan, into the drying tub.

The conventional laundry drying machine comprises a housing provided with a door on a front surface thereof and a heater installed on a rear part thereof, a drying tub having a cylindrical shape horizontally installed in the housing, a hot air inlet duct positioned on a rear surface of the housing for guiding hot air generated through a heater into the drying tub, a hot air outlet duct for guiding the hot air from the drying tub to the outside, and a blast fan positioned in the hot air outlet duct for generating suction force and air blowing force.

The laundry drying machine further comprises a front panel rotatably supporting a front end of the drying tub, and a rear panel rotatably supporting a rear end of the drying tub. The hot air outlet duct and the hot air inlet duct are respectively arranged on the front panel and the rear panel, thereby allowing the hot air to pass through the drying tub to dry the laundry contained in the drying tub.

In order to prevent the laundry from being introduced into the hot air outlet duct, a grill member having a grid pattern is provided on the front panel. A humidity sensor for measuring dryness of the laundry is attached to the grill member.

In the above-described conventional laundry drying machine, the grill member, which has the grid pattern to pass air therethrough, has a relatively low strength compared to other components. In case that the grill member is exposed to heat of a high temperature when the laundry drying machine is in use for a long period of time, the grill member is easily deformed. The deformation of the grill member causes unstable installation of the humidity sensor on the grill member, thereby generating errors in detecting dryness of the laundry by means of the humidity sensor.

### SUMMARY OF THE INVENTION

Additional aspects and/or advantages of the invention will be set forth in part in the description which follows and, in part, will be obvious from the description, or may be learned by practice of the invention.

An aspect of the present invention is to provide a laundry drying machine, which measures precise dryness of laundry even when the laundry drying machine is in use for a long period of time.

In accordance with one aspect of the present invention, a laundry drying machine comprises: a housing defining an external appearance; a drying tub rotatably installed in the housing; a front panel rotatably supporting a front end of the drying tub; and a humidity sensor installed on the front panel, for detecting dryness of laundry contained in the drying tub.

According to aspects of the present invention, a support portion having a disk shape protrudes from the front panel so that the outer circumference of the support portion rotatably supports the inner circumference of the front end of the drying tub, and the humidity sensor is installed on the inner circumference of the support portion.

According to an aspect of the present invention, a grill member for sucking air circulating in the drying tub is installed on a lower part of the support portion, and the humidity sensor is positioned adjacent to the lower part of the grill member.

According to an aspect of the present invention, a grill reception groove for passing the frill member therethrough is formed in the inner circumference of the support portion, and the humidity sensor is installed on a sensor reception part upwardly extended integrally from a part of the support portion adjacent to the grill reception groove.

According to an aspect of the present invention, the humidity sensor includes a pair of electrodes spaced from each other by a predetermined distance, and detect dryness of the laundry based on the variation of a resistance value between the two electrodes.

According to an aspect of the present invention, the front panel is made of steel so as to support the total weight of the drying tub and the laundry contained in the drying tub.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a laundry drying machine in accordance with an aspect of the present invention;

FIG. 2 is a schematic longitudinal-sectional view illustrating the structure of the laundry drying machine in accordance with an aspect of the present invention; and

FIG. 3 is a perspective view illustrating the installation of a front panel and a humidity sensor of the laundry drying machine in accordance with an aspect of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

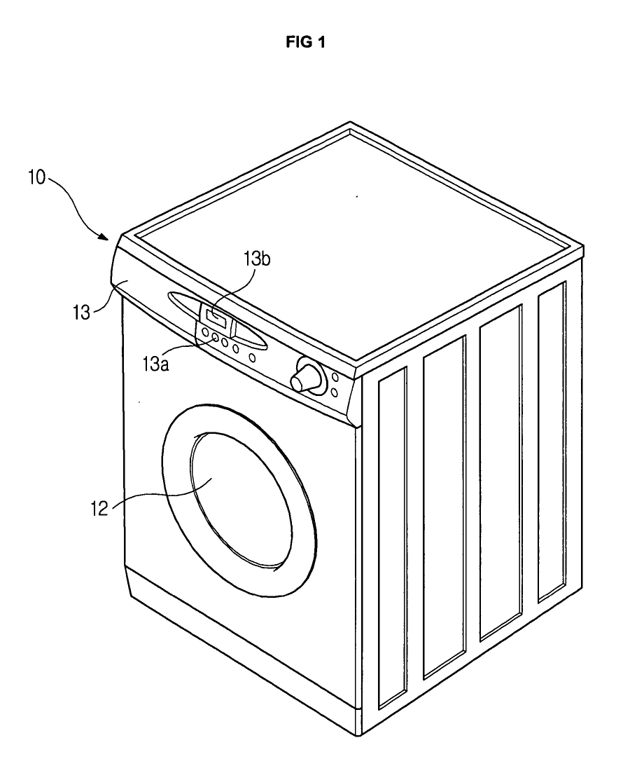

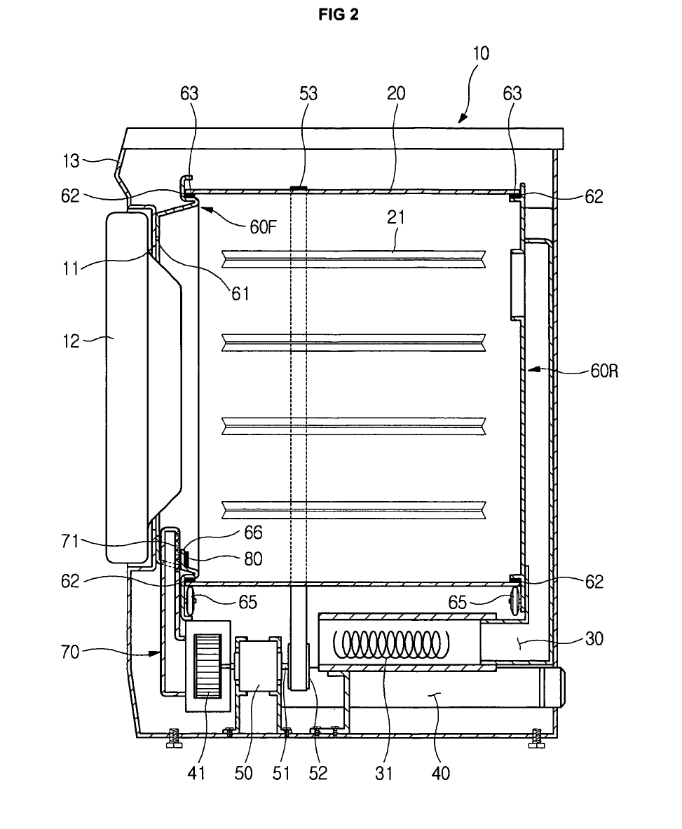

As shown in FIGS. 1 and 2, a laundry drying machine according to an aspect of the present invention comprises a housing 10 defining an external appearance, a drying tub 20 having a drum shape rotatably installed in the housing 10, a hot air inlet duct 30 for guiding hot air into the drying tub 20, and a hot air outlet duct 40 for guiding the hot air from the drying tub 20 to the outside of the laundry drying machine.

An opening 11 through which laundry is into or taken output of the laundry drying machine therethrough is formed through a front surface of the housing 10. A door 12 for opening and closing the opening 11 is hinged to one side of the opening 11. A control panel 13, which is positioned on the upper part of the front surface of the housing 10, includes an operating button 13a for controlling the operation of the laundry drying machine and a display 13b for displaying the operating state of the laundry drying machine. However, it is understood that other types of inputs and indicators can be used instead of or in addition to the shown buttons 13a and display 13b.

The hot air inlet duct 30 includes a heater 31 for heating air flowing therethrough to generate hot air. One end of the hot air inlet duct 30 is opened and the other end of the hot air inlet duct 30 is connected to the drying tub 20 to supply the hot air to the drying tub 20. The hot air outlet duct 40 includes a blast fan 41 installed therein for generating suction force and air blowing force, and allows the hot air to pass through the hot air inlet duct 30, the drying tub 20 and the hot air outlet duct 40 and then to be exhausted to the outside.

The drying tub 20 is fixed in the housing 10 such that the drying tub 20 is rotated by rotary force generated from a driving motor 50, installed in a lower part of the inside of the housing 10, through a belt 53 driven by a pulley 52. Here, the driving motor 50 simultaneously drives the drying tub 20 and the blast fan 41. For this reason, both ends of a rotary shaft 51 of the driving motor 50 are extended so that one extended end of the rotary shaft 51 is connected to the blast fan 41 to rotate the blast fan 41 and the other extended end of the rotary shaft 51 is provided with a pulley 52 to transmit the rotary force to the drying tub 20 through the belt 53 surrounding the drying tub 20 so as to rotate the drying tub 20. A lifter 21 protrudes from the inner surface of the drying tub 20 and lifts the laundry contained in the drying tub 20 to a predetermined height and then drops the laundry. However, it is understood that other transmission mechanisms can be used and that other devices can be used to tumble the laundry.

A front panel 60F for covering the front part of the drying tub 20 and rotatably supporting the front end of the drying tub 20 is installed in front of the drying tub 20. A rear panel 60R for covering the rear part of the drying tub 20 and rotatably supporting the rear end of the drying tub 20 is installed at the rear of the drying tub 20.

Support portions 62 having a disk shape for rotatably supporting the inner circumferences at both ends of the drying tub 20 are respectively protruded from the front panel 60F and the rear panel 60R. The outer circumferences of the support portions 62 rotatably support the inner circumference of the drying tub 20. Friction members 63 having a small friction coefficient are respectively arranged on the outer circumferences of the support portions 62, thereby allowing the front and rear ends of the drying tub 20 to be supported by the two support portions 62. Accordingly, when the rotary force of the driving motor 50 is transmitted to the drying tub 20, the front and rear ends of the drying tub 20 are slidably rotated along the surfaces of the friction members 63 positioned on the support portions 62.

The hot air inlet duct 30 for circulating the hot air into the drying tub 20 therethrough is installed in the rear panel 60R, thereby allowing the rear panel 60R to receive the hot air transmitted therefrom. The hot air outlet duct 40 is installed in the front panel 60F, thereby allowing the front panel 60F to exhaust the hot air therethrough. As a result, the hot air is transmitted from the rear part of the drying tub 20 provided with the hot air inlet duct 30 to the front part of the drying tub 20 provided with the hot air outlet duct 40, thus drying the laundry contained in the drying tub 20. However, it is understood that the ducts 30, 40 can be disposed on other sides or collocated on a same side according to aspects of the invention.

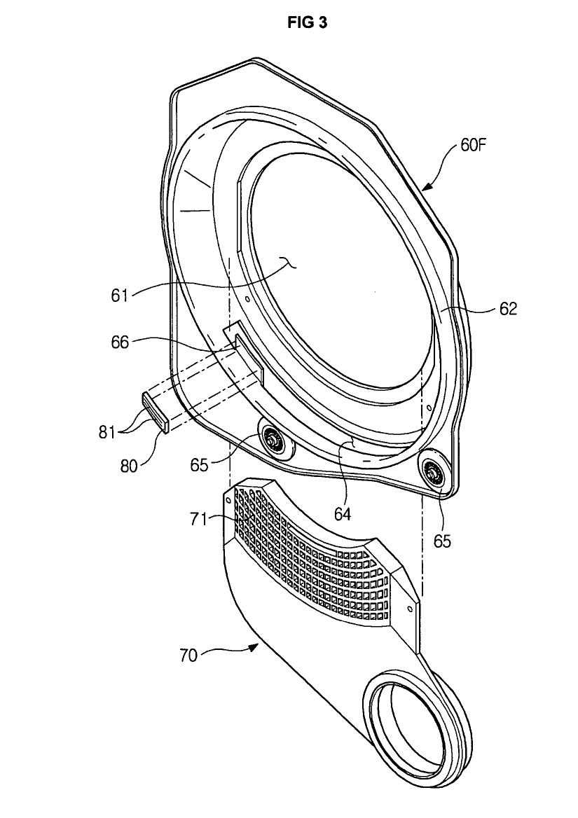

As shown in FIG. 3, a through hole 61, through which the laundry is put into and taken out of the drying tub 20 therethrough, is formed through an inner part of the support portion 62 of the front panel 60F. A grill member 70, for allowing only the hot air to pass therethrough and be introduced into the hot air outlet duct 40 so as to prevent the laundry from being introduced into the hot air outlet duct 40, is installed at an end of the hot air outlet duct 40.

The grill member 70 is provided with an inlet 71 having a grid pattern for passing the hot air but catching the laundry. A grill reception groove 64 for passing the grill member 70 is formed in the inner circumference of the support portion 62 of the front panel 60F, thereby allowing the grill member 70 to be protruded toward the inner side of the disk-shaped support portion 62 of the front panel 60F to suck the hot air of the drying tub 20. While shown as a grill, it is understood that other mechanisms, such as meshes and/or bars can be used to prevent laundry from being introduced into the duct 40. Moreover, the material of the grill member 70 can be the same or different than the material of the support portion 62.

The laundry drying machine an aspect of the present invention further comprises a humidity sensor 80 for detecting dryness of the laundry. The humidity sensor 80 is fixedly installed on the front panel 60F. The front panel 60F and the rear panel 60R are made of a material having a predetermined strength or more so as to support the total weight of the drying tub 20 and the laundry contained in the drying tub 20, thus being scarcely deformed even when the laundry drying machine is in use for a long period of time, as well as potentially being made of a material stronger than the material making up the grill member 70. Accordingly, the humidity sensor 80, which is installed on the front panel 60F, maintains its stable installation for a long time. In this embodiment of the present invention, the front panel 60F and the rear panel 60R are made of steel, and rollers 65 are hinged to the lower parts of the front panel 60F and the rear panel 60R so as to rotatably support the drying tub 20. However, it is understood that other materials can be used.

The shown humidity sensor 80 includes a pair of electrodes, which are spaced from each other by a predetermined distance, and senses the dryness of the laundry by measuring a resistance value between the two electrodes 81. That is, in case that the laundry contains high moisture content, current easily flows between the two electrodes 81 due to the moisture and the resistance between the two electrodes 81 is lowered. When the laundry contains low moisture content, current cannot flow well between the two electrodes 81 and the resistance between the two electrodes 81 is heightened. Thus, the dryness of the laundry can be sensed by measuring the resistance value between the two electrodes 81. However, it is understood that other types of sensors can be used without restriction.

The humidity sensor 80 is installed on the lower part of the inner circumference of the support portion 62. Since the laundry is collected in the lower part of the drying tub 20 by gravity, the humidity sensor 80 is installed in the lower part of the drying tub 20 in order to precisely sense the dryness of the laundry according to an aspect of the present invention.

In order to install the humidity sensor 80, a sensor reception part 66 having a flat plate shape upwardly extended integrally from a part of the support portion adjacent to the grill reception groove 64 is installed on the support portion 62. The humidity sensor 80 is fixedly installed on the front panel 60F by fixing the humidity sensor 80 to the sensor reception part 66.

Hereinafter, the operation and effects of the above-described laundry drying machine in accordance with an aspect of the present invention will be described in detail.

First, wet laundry is put into the drying tub 20, and the drying tub 20 is closed by the door 12. When the laundry drying machine is operated in a dry mode, the heater 31 and the driving motor 50 are operated. Thereby, the hot air generated from the blast fan 41 through the heater 31 is introduced into the drying tub 20 through the hot air inlet duct 30. The hot air introduced into the drying tub 20 flows by the suction force of the blast fan 41, evaporates the moisture contained in the wet laundry, and is exhausted together with the evaporated moisture to the outside of the drying tub 20 through the hot air outlet duct 40.

Here, the humidity sensor 80 detects the dryness of the laundry by measuring the resistance value between the two electrodes 81. Whether t the dry mode of the laundry drying machine is continued is determined by the detected dryness of the laundry. Thereby, the proper degree of the dryness of the laundry is maintained.

As is apparent from the above description, an aspect of the present invention provides a laundry drying machine, in which a humidity sensor is installed on a front panel having a predetermined strength or more so as to support the total weight of a drying tub and laundry contained in the drying tub, thereby maintaining the stable installation of the humidity sensor for a long period of time and reducing the generation of errors of the humidity sensor.

While described in terms of a laundry drying machine, it is understood that the present invention can be used in other appliances in which humidity is detected and which have a grill through which air passes and which is susceptible to deformation due to prolonged exposure to heat.

Although a few embodiments of the present invention have been shown and described, it would be appreciated by those skilled in the art that changes may be made in these embodiments without departing from the principles and spirit of the invention, the scope of which is defined in the claims and their equivalents.

1. A laundry drying machine comprising:
a housing defining an external appearance;
a drying tub rotatably installed in the housing;
a front panel rotatably supporting a front end of the drying tub; and
a humidity sensor, installed on the front panel, for detecting dryness of laundry contained in the drying tub.

2. The laundry drying machine according to claim 1, further comprising a support portion having a disk shape protruding from the front panel so that an outer circumference of the support portion rotatably supports an inner circumference of the front end of the drying tub, wherein the humidity sensor is installed on the inner circumference of the support portion.

3. The laundry drying machine according to claim 2, further comprising a grill member through which air circulating in the drying tub is removed from the drying tub and which is installed on a lower part of the support portion, wherein the humidity sensor is positioned adjacent to the lower part of the grill member.

4. The laundry drying machine according to claim 2, further comprising a grill reception groove for passing the grill member therethrough into the support portion and which is formed in the inner circumference of the support portion, and the humidity sensor is installed on a sensor reception part upwardly extended integrally from a part of the support portion adjacent to the grill reception groove.

5. The laundry drying machine according to claim 1, wherein the humidity sensor includes a pair of electrodes spaced from each other by a predetermined distance, and detects dryness of the laundry based on a variation of a resistance value between the two electrodes.

6. The laundry drying machine according to claim 1, wherein the front panel is made of steel so as to support the total weight of the drying tub and the laundry contained in the drying tub.

7. A drying machine comprising:
a drying tub into which items to be dried are inserted;
a panel rotatably supporting the drying tub and having a sensor holder;
a humidity sensor installed at the sensor holder; and
a grill disposed apart from the sensor holder and through which air passes into and/or out of the drying tub.

8. The drying machine of claim 11, wherein the panel is made of a material stronger than a material making up the grill.
